(19) United States
(12) Patent Application Publication
(10) Pub. No.: US 2005/0066830 A1
(43) Pub. Date: Mar. 31, 2005

(54) Image forming device for planographic printing plates

(75) Inventors: Ichirou Miyagawa, Kanagawa (JP); Yoshinori Katoh, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/947,130

(22) Filed: Sep. 23, 2004

(30) Foreign Application Priority Data
Sep. 29, 2003 (JP) 2003-336723

(51) Int. Cl. B41C 1/10

(52) U.S. Cl. 101/463.1

(57) ABSTRACT

An image forming device for planographic printing plates which, before printing, carries out water developing and heating processing after the water developing, of a planographic printing plate which can be developed by water, the image forming device includes: a laser recording section which forms a latent image by laser-exposing an image recording layer portion of the planographic printing plate at a weak laser power of an extent that one-third, at a surface side, of the image recording layer in a direction of thickness thereof can be hardened; a water developing section which strips film of unexposed portions of the image recording layer by causing a film-stripping medium, which is selected from the group consisting of steam, water, aqueous liquids, and mixtures of a gas and at least one of water and an aqueous liquid, to hit the planographic printing plate on which a latent image has been formed at the image recording layer portion by the laser recording section; and a post-development heating processing section which heats the planographic printing plate, after the planographic printing plate has been subjected to water developing processing by the water developing section, and hardens the image recording layer portion.

### CROSS-REFERENCE TO RELATED APPLICATION

This application claims priority under 35 USC 119 from Japanese Patent Application No. 2003-336723, the disclosures of which are incorporated by reference herein.

### BACKGROUND OF THE INVENTION

1. Field of the Invention

The present invention relates to an image forming device for planographic printing plates which subjects a planographic printing plate, which has undergone exposure processing by using laser light or the like, to developing processing so as to manufacture a plate.

2. Description of the Related Art

Generally, photosensitive planographic printing plates (so-called PS plates) are used in offset printing. In the field of planographic printing plates, there have been proposed planographic printing plates utilizing a CTP (computer-to-plate) system which directly manufactures a printing plate by carrying out laser exposure processing on the basis of digital data of a computer or the like.

In recent years, in such CTP systems, there has been proposed an on-press development system in which, after exposure onto a planographic printing plate, the planographic printing plate is, without being subjected to developing processing, set at a printing press and printed.

This on-press development system utilizes a planographic printing plate which is structured as follows: an aluminum plate having a hydrophilic surface which has been anodized and roughened is used as the support. An image forming layer is formed on this hydrophilic surface. The image forming layer contains hydrophobic thermoplastic polymer particles which are dispersed in a hydrophilic binder and can coalesce due to heat. This image forming layer, or a layer adjacent thereto, contains a compound which can convert light into heat.

In this on-press development system, exposure processing of the planographic printing plate is carried out by using laser light (emitted from a laser diode) of a wavelength range of, for example, the infrared (IR) light or near infrared light region.

In the exposure processing of the planographic printing plate, the laser light, which is illuminated onto the image forming layer in accordance with the required image, is converted into heat. The hydrophobic thermoplastic polymer particles contained in the image forming layer are heated to or above the coagulating temperature and coagulate, such that hydrophobic agglomerates are formed in the hydrophilic layer. In regular water or aqueous liquids, these agglomerates are insoluble and are not desorbed or dispersed.

In this on-press development system, a planographic printing plate which has been subjected to exposure processing in this way is, for example, set on a printing cylinder of a printing press. Then, the printing press is started-up, a wetting agent roller which supplies an aqueous wetting liquid is made to roll on the image forming layer of the planographic printing plate, an inking roller is made to roll on the image forming layer of the planographic printing plate, and the printing operation is carried out. As a result, the hydrophobic agglomerates which had coagulated (hardened) in the image forming layer of the planographic printing plate remain, while the other portions of the hydrophilic layer being removed and dispersed in regular water or an aqueous liquid, whereby development is effected. Usually, after the printing cylinder is rotated about 10 times, the first clean and serviceable printing can be carried out (see, for example, Japanese Patent No. 2938397).

Moreover, as the planographic printing plate on which the conventional on-press development can be carried out (i.e., a planographic printing plate in which image formation is carried out by removing unhardened portions and dispersing these portions in water or a wetting liquid after exposure), it is possible to use a planographic printing plate in which the image recording layer provided on the support of the planographic printing plate contains microcapsules which encapsulate a heat-reactive compound, a polymerization initiator, and a light-heat converting agent.

The polymerization initiator and the light-heat converting agent, such as a radical initiator or an acid generating agent, may exist either within microcapsules or outside of microcapsules. Namely, it suffices for them to be added by at least one of within microcapsules and outside of microcapsules in the image recording layer matrix. However, from the standpoint of storage stability, it is preferable that the polymerization initiator be added in the image recording layer matrix.

From the standpoint of sensitivity, it is preferable that the light-heat converting agent be added within microcapsules.

The following has been proposed in such a conventional planographic printing plate: due to the image recording layer provided on the support being exposed by an active beam, the film of the image recording layer hardens such that a continuous, strong covering film is formed. The film at the unexposed portions is washed off by water or an aqueous liquid (the film of the unexposed portions is removed by dispersed by the water or the aqueous liquid).

It has been proposed (see, for example, Japanese Patent No. 2639748) to carry out developing processing of this planographic printing plate by a developing method of washing-off by using water and a brush, a mop, a sponge, or the like, or by a developing method in which the planographic printing plate is attached to a conventional offset printing press widely-used for various purposes, and directly on the printing press, the image recording layer at the unexposed portions is removed by a water rod roller and an inking roller.

In the above-described, conventional on-press development systems, a metal plate of aluminum or the like is used as the support of the planographic printing plate, and in a case in which laser exposure processing is carried out, a vicinity of the top surface (in the direction of thickness of the layer) of the image forming layer of the planographic printing plate can be sufficiently heated to or above the coagulation temperature by laser light which is illuminated at a high output within a range such that ablation (the phenomenon of portions illuminated at a strong energy being burnt off) does not occur.

However, in a vicinity of the bottom surface (in the direction of thickness of the layer) of the image forming layer, the heat energy converted from the illuminated laser light diffuses and escapes rapidly at the support side where the heat conductivity is high. Therefore, in a case in which laser light is illuminated at the maximum output at which ablation does not occur, at the portion in the vicinity of the interface between the support and the image forming layer (the heat recording layer), the temperature cannot be sufficiently raised to the coagulation temperature or higher, and hardening of the image forming layer portions to which the laser light has been illuminated (the image portions) does not proceed sufficiently. Therefore, the strength of the image portions is insufficient. When printing is carried out by using such a planographic printing plate, the more sheets that are printed, the easier it is for the image portions to become absent, and the ability to sustain a good printing quality over a large number of printings is poor.

Further, in the above-described systems in which the conventional planographic printing plate is developed on a printing press, immediately after carrying out the developing step by using the means for printing processing at the printing press, serviceable printed matter is printed at the same printing press.

Therefore, in the case of the above-described planographic printing plate in which exposure processing is carried out and a latent image is formed, developing is not carried out in advance of printing, and thus the image cannot be visually confirmed before printing. Accordingly, until printing is carried out, simultaneously with developing, by washing-off and removing the non-image portions (unexposed portions) at the printing press, it is not possible to confirm (carry out plate inspection as to) whether or not the image which should be recorded on the planographic printing plate has been recorded correctly.

### SUMMARY OF THE INVENTION

An object of the present invention is to provide an image forming device for planographic printing plates in which, before a planographic printing plate is set at a printing press, the exposed planographic printing plate can be easily washed and developed well, and the ability to sustain a good printing quality over a large number of printings can be improved.

In a first aspect of the present invention, an image forming device for planographic printing plates which forms images on planographic printing plates which can be developed by water, has a water developing means which removes unexposed portions of an image recording layer by blowing, from a steam nozzle, steam of a predetermined temperature and a predetermined jetting pressure, onto the planographic printing plate at which a latent image has been formed by laser exposure on the image recording layer portion.

In the above-described structure, development is promoted due to the film at the portions of the image recording layer of the planographic printing plate, which portions have not been exposed and at which portions the film of the image recording layer has not hardened, being steeped in the heat of the steam which is the vapor of the water or the aqueous liquid, and being dissolved by the moisture, and the jetting pressure of the steam being applied thereto. In this way, washing-off (the stripping and dispersing and removal by steam of the unexposed portions) can be carried out in a short period of time by using a small amount of moisture. On the other hand, the film of the hardened portions remains on the surface of the planographic printing plate and forms an image.

Namely, the present aspect is convenient in that the planographic printing plate can be developed and inspected before being set at a printing press.

In a second aspect of the present invention, the water developing means of the image forming device for planographic printing plates based on the first aspect has a steam generator/suction filter which generates steam of a predetermined temperature and a predetermined pressure, feeds the steam to the steam nozzle for use, then sucks-in and recovers the steam by a suction nozzle and filters out and removes stripped-off remains of the image recording layer, and generates stream by utilizing the remaining liquid.

In accordance with the present aspect, in addition to the operation and effects of the image forming device for planographic printing plates based on the above-described first aspect, water can be conserved by reusing the steam which has been jetted from the steam nozzle.

In a third aspect of the present invention, an image forming device for planographic printing plates which forms images on planographic printing plates which can be developed by water, includes: a water developing tank storing one of water and an aqueous liquid; conveying means for conveying the planographic printing plate such that an image recording layer, on which a latent image has been formed by laser exposure, passes through a position of a predetermined depth near a liquid surface of the water developing tank; and a jetting nozzle jetting compressed air toward the image recording layer of the planographic printing plate passing through an interior of the water developing tank, and carrying out water developing processing.

In the above-described structure, when compressed air is jetted out from the jetting nozzle toward the planographic printing plate which is directly beneath the liquid surface of the water or the aqueous liquid, the liquid surface of the water or the aqueous liquid which is above the planographic printing plate is locally pressed by the compressed air jetted from the jetting nozzle and sinks-in, and the surrounding water attempts to flow into this portion.

Further, the water or the aqueous liquid, to which pressure is applied by the compressed air jetted from the jetting nozzle, hits the image recording layer of the surface of the planographic printing plate, and washes off the film portions of the image recording layer which are unexposed and have not hardened and thus remain as water-soluble material.

At this time, on the planographic printing plate, the film of the portions where the image recording layer has hardened remain on the surface of the planographic printing plate, such that an image is formed.

In a fourth aspect of the present invention, a filtering/circulating device, which extracts, through a circulating pipe, the one of the water and the aqueous liquid stored in the water developing tank, and filters out and removes remains of peeled-off film of the image recording layer by a filter, and thereafter feeds the filtered liquid by a pump so as to return it to the interior of the water developing tank, is connected to the water developing tank of the image forming device for planographic printing plates based on the above-described third aspect.

In accordance with the present aspect, in addition to the operation and effects of the image forming device for planographic printing plates based on the above-described third aspect, the water or the aqueous liquid stored in the water developing tank can be reused.

In a fifth aspect of the present invention, an image forming device for planographic printing plates which forms images on planographic printing plates which can be developed by water, includes conveying means for conveying a planographic printing plate at which a latent image has been formed by laser exposure on an image recording layer thereof; and a jetting nozzle blowing out water or an aqueous liquid, which has been pressurized, toward the image recording layer of the planographic printing plate being conveyed by the conveying means, and stripping (and scattering) and removing film of unexposed portions, and thereby carrying out water developing processing.

In accordance with the present aspect, the pressurized water or aqueous liquid is blown out with force from the jetting nozzle toward the surface of the planographic printing plate. In this way, the film portions of the image recording layer, which are unexposed and are not hardened and remain as water soluble material at the image recording layer of the surface of the planographic printing plate, are washed-off. On the other hand, the film of the portions where the image recording layer has hardened remain on the surface of the planographic printing plate. An image is thereby formed.

In a sixth aspect of the present invention, the image forming device for planographic printing plates based on the above-described fifth aspect has a drain disposed at a lower side of a conveying path, a circulating pipe, a filtering/circulating device, and a pressurizing device, wherein the drain receives therein one of the water and the aqueous liquid which has been jetted out from the jetting nozzle, and the one of the water and the aqueous liquid is fed from the drain through the circulating pipe to the filtering/circulating device, and stripped-off remains of the image recording layer are filtered out and removed from one of the water and the aqueous liquid by the filtering/circulating device, and the one of the water and the aqueous liquid which remains is fed to the pressurizing device through the circulating pipe, and the one of the water and the aqueous liquid which is pressurized at the pressurizing device is again jetted out from the jetting nozzle.

In accordance with the present aspect, in addition to the operation and effects of the image forming device for planographic printing plates based on the above-described fifth aspect, the water or the aqueous liquid jetted from the jetting nozzle is reused, and the consumed amount thereof can be reduced.

In a seventh aspect of the present invention, the image forming device for planographic printing plates based on the above-described fifth or sixth aspect further has air mix-in means for mixing air into the one of the water and the aqueous liquid which is jetted out from the jetting nozzle.

In accordance with the present aspect, in addition to the operation and effects of the image forming devices for planographic printing plates based on the above-described fifth and sixth aspects, the amount of the water or the aqueous liquid jetted from the jetting nozzle is reduced, such that water developing processing can be carried out by an amount of water or aqueous liquid which is small overall.

In an eighth aspect of the present invention, the image forming device for planographic printing plates based on any of the above-described first through seventh aspects further has a post-development heating processing section which heats the planographic printing plate, after the planographic printing plate has been subjected to the water developing processing, and hardens the image recording layer portion.

In accordance with the present aspect, the image recording layer portion at the planographic printing plate is heated and hardened by the post-development heating processing section, and the ability to sustain a good printing quality over a large number of printings can thereby be improved.

In a ninth aspect of the present invention, the image forming device for planographic printing plates based on the above-described eighth aspect further has compressed air blowing means for blowing compressed air onto a surface of the planographic printing plate such that the surface is dried and cleaned, before the planographic printing plate, which has been subjected to the water developing processing, is conveyed to the post-development heating processing section.

In accordance with the present aspect, at the time of the heating processing at the post-development heating processing section, it is possible to prevent the water soluble material, which is included in the moisture remaining on the developed surface of the planographic printing plate, from being heated and hardened and adhering, and to prevent the stripped-off remains of the image recording layer from being heated and hardened and adhering.

Namely, in accordance with the image forming device for planographic printing plates of the present invention, there is provided the excellent effect that, before a planographic printing plate is set at a printing press, the exposed planographic printing plate can be washed, and the ability to sustain a good printing quality over a large number of printings can be improved.

### BRIEF DESCRIPTION OF THE DRAWINGS

FIG. 1 is a perspective view showing the overall schematic structure of an image forming device for planographic printing plates relating to a first embodiment of the present invention.

FIG. 2 is a structural diagram showing the overall schematic structure of an image forming device for planographic printing plates relating to a second embodiment of the present invention.

FIG. 3 is an enlarged explanatory diagram of main portions, showing the operation of water developing processing in the image forming device for planographic printing plates relating to the second embodiment of the present invention.

FIG. 4 is a structural diagram showing the overall schematic structure of an image forming device for planographic printing plates relating to a third embodiment of the present invention.

FIG. 5 is an enlarged explanatory diagram of main portions, showing the operation of water developing processing in the image forming device for planographic printing plates relating to the third embodiment of the present invention.

FIG. 6 is an enlarged sectional view showing main portions of a planographic printing plate after exposure, which is to be subjected to water developing processing in the image forming device for planographic printing plates relating to any of the above-described embodiments of the present invention.

FIG. 7 is an enlarged sectional view showing main portions of a planographic printing plate which has been subjected to water developing processing in the image forming device for planographic printing plates relating to any of the above-described embodiments of the present invention.

FIG. 8 is an enlarged sectional view showing main portions of a planographic printing plate which has been subjected to heating processing in the image forming device for planographic printing plates relating to any of the above-described embodiments of the present invention.

FIG. 9 is an enlarged sectional view of main portions, showing a scattering preventing means which is added to an air gun portion in the image forming device for planographic printing plates relating to the first embodiment of the present invention.

### DETAILED DESCRIPTION OF THE INVENTION

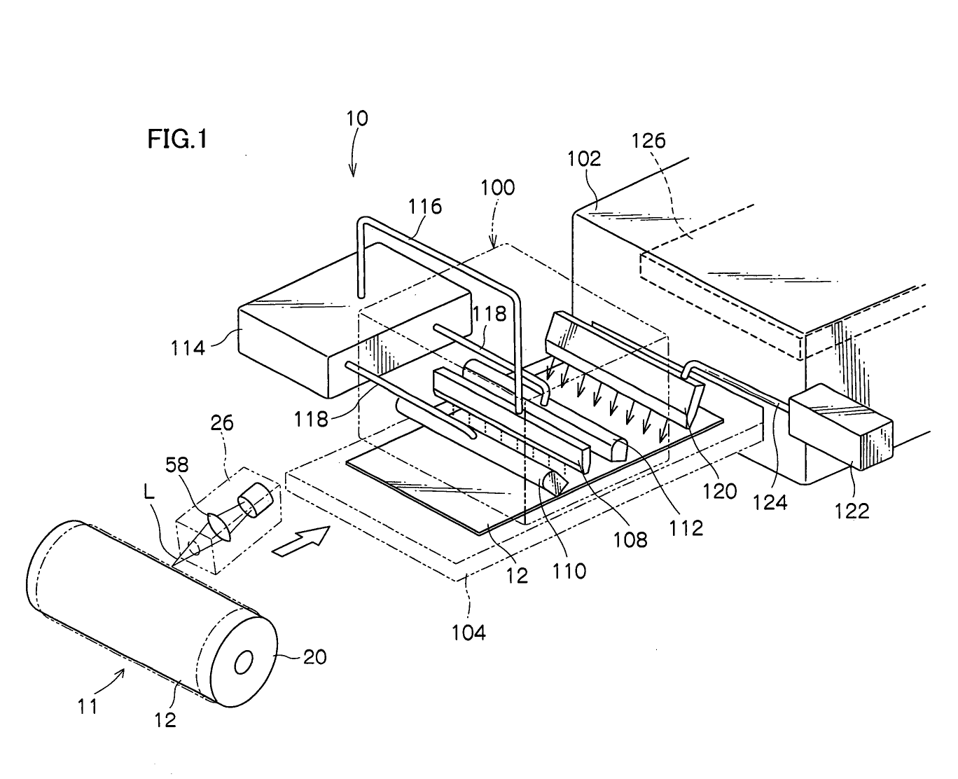

Image forming methods and image forming devices for planographic printing plates relating to embodiments of the present invention will be described with reference to FIGS. 1 through 8.

The schematic structure of an image forming device relating to a first embodiment of the present invention is shown in FIG. 1. In an image forming device 10 shown in FIG. 1, image forming processing is carried out by using a laser recording section 11, a water developing section 100 which is a water developing means, and a post-development heating processing section 102. Note that, in the image forming device main body, the water developing section 100 and the post-development heating processing section 102 may be structured integrally, and the laser recording section 11 may be structured as a separate body. Further, the image forming device 10 may be structured such that the water developing section 100 and the post-development heating processing section 102 are structured separately, and a planographic printing plate 12, which is subjected to water developing processing in the water developing section 100, is conveyed to and processed in succession at the post-development heating processing section 102.

In the image forming device 10, at the laser recording section 11, a precursor of the planographic printing plate 12 is subjected to laser exposure processing by being scanned and exposed by near infrared lasers (hereinafter called “NIR lasers L”) which are modulated on the basis of digital image information. An image (latent image) corresponding to the digital image information is formed on the precursor of the planographic printing plate 12.

The planographic printing plate 12 used here is a structured such that an image recording layer (photosensitive layer), which contains a thermosetting, heat-sensitive material, is formed on a support, and is structured such that so-called water development thereof is possible in which the planographic printing plate 12 is developed by being washed by water or an aqueous liquid (a developing liquid which is water or an appropriate aqueous solution). For example, a planographic printing plate structured by using the compounds disclosed in Japanese Patent Application No. 2003-116162 can be used.

The planographic printing plate 12 has an image recording layer which is formed as a film on the surface of a support formed from aluminum or an aluminum alloy. This image recording layer contains a hydrophobicizing precursor and a light-heat converting agent.

Note that a layer containing, for example, a polymerization initiator, a light-heat converting agent, and microcapsules encapsulating a heat-reactive compound, can be used as the image recording layer of the planographic printing plate 12.

The light-heat converting agent and the polymerization initiator such as a radical initiator or an acid generating agent may exist either within microcapsules or outside of microcapsules. Namely, it suffices for them to be added by at least one of within microcapsules and outside of microcapsules in the image recording layer matrix. However, from the standpoint of storage stability, it is preferable that the polymerization initiator be added in the image recording layer matrix.

From the standpoint of sensitivity, it is preferable that the light-heat converting agent be added within microcapsules.

Although not illustrated, in the image forming device 10, a conveying device, which carries out the operations of conveying in and conveying out the planographic printing plate 12, is disposed at a position between the laser recording section 11 and the water developing section 100. The conveying device conveys the planographic printing plate 12 into the laser recording section 11, and conveys the planographic printing plate 12, for which exposure processing has been completed, out from the laser recording section 11 and into the water developing section 100.

As shown in FIG. 1, an outer drum 20, which is solid cylindrical and to and from which a single planographic printing plate 12 can be attached and removed, is installed in the laser recording section 11 so as to be able to be driven to rotate. The leading end portion and the trailing end portion of the planographic printing plate 12 can be attached to and removed from the outer peripheral surface of the outer drum 20 by respective chucking means.

In the laser recording section 11, an exposure head 26 is disposed so as to oppose the outer drum 20. The exposure head 26 is installed so as to be able to move and scan along a subscanning direction by an unillustrated feed mechanism. Moreover, an unillustrated LD light source device for supplying the NIR lasers L to the exposure head 26 is disposed in the laser recording section 11 at a position lower than the outer drum 20.

The recording head 26 in the laser recording section 11 focuses, on the precursor of the planographic printing plate 12 set on the outer drum 20, the NIR lasers L emitted from plural optical fibers connected to the LD light source device, by a lens unit 58 serving as a focusing optical system, so as to carry out exposure by beam spots having a predetermined configuration and size.

The exposure head 26 is a multi-beam type exposure head which can simultaneously project, onto the precursor of the planographic printing plate 12, a plurality of beam spots. The plurality of beam spots are lined-up along the subscanning direction on the precursor of the planographic printing plate 12, or are lined-up on a straight line which is tilted slightly with respect to the subscanning direction.

In the laser recording section 11 which is structured in this way, the precursor of the planographic printing plate 12 set on the outer drum 20 is scanned and exposed by the NIR lasers L which have been modulated on the basis of digital image information, such that a latent image corresponding to the digital image information is formed on the image recording layer of the precursor of the planographic printing plate 12.

In the image forming device 10, as will be described later, after laser exposure processing is carried out on the planographic printing plate 12, water developing processing and post-development heating processing are carried out, whereby the planographic printing plate 12 on which an image is formed is completed.

Therefore, in the laser recording section 11, exposure is of course carried out at an amount of laser power (the amount of light for exposure) which is less than the amount of laser power which causes ablation at the surface of the image recording layer. Moreover, the precursor of the planographic printing plate 12 is scanned and exposed by laser light (the NIR lasers L) of a relatively low laser power (i.e., a relatively small amount of light for exposure) which is capable of hardening of at least the surface side portion of the image recording layer of the planographic printing plate 12, which portion is in the vicinity of the surface layer in the direction of thickness thereof (preferably, a portion which is ⅓ or more of the layer thickness of the image recording layer). For example, the precursor of the planographic printing plate 12 is scanned and exposed by laser light (the NIR lasers L) of a laser power which is half of (or more than half of) that in the conventional art.

Accordingly, because the LD light source device of the laser recording section 11 can be a relatively low output device, the LD light source device can be manufactured inexpensively, without using an expensive, high-output LD light source.

In the laser recording section 11 which is structured in this way, the precursor of the planographic printing plate 12 is conveyed by the conveying device, and the leading end portion and the trailing end portion of the precursor of the planographic printing plate 12 are held on the outer peripheral surface of the outer drum 20 by using the chucking mechanisms. The entire planographic printing plate 12 is thereby set in a state of being wound around the outer peripheral surface of the outer drum 20 while being tightly fit thereto.

In the laser recording section 11, in the state in which the precursor of the planographic printing plate 12 is wound around the outer drum 20, the outer drum 20 is rotated in the main scanning direction, and the laser light, which corresponds to the image data of the image to be recorded on the precursor of the planographic printing plate 12, is scanned in the subscanning direction which is orthogonal to the main scanning direction. A two-dimensional image is thereby recorded on the precursor of the planographic printing plate 12.

In the laser recording section 11, when the exposure (image formation) processing of the planographic printing plate 12 set on the outer drum 20 as described above is completed, the outer drum 20 is rotated in the direction of rotating reversely, and the planographic printing plate 12 is released from the outer drum 20 by the chucking mechanisms.

Interlockingly with these operations, the conveying device conveys the planographic printing plate 12, which has been conveyed out from the outer peripheral surface of the outer drum 20, into the water developing section 100.

As shown in FIG. 1, in the water developing section 100 which is the water developing means, a steam developing device is disposed above a conveying portion 104 which is a conveying means which is disposed so as to structure the conveying path of the planographic printing plate 12.

The steam developing device has a steam nozzle 108, and suction nozzles 110, 112 which are disposed in vicinities of the planographic printing plate 12 conveying direction upstream side and downstream side of the steam nozzle 108, respectively.

The steam nozzle 108 is structured such that nozzles are lined-up linearly along the entire width in the transverse direction of the planographic printing plate 12 (the direction orthogonal to the conveying direction of the planographic printing plate 12). A hose 116, which is pulled-out from a steam generator/suction filter 114, is connected to the steam nozzle 108.

The steam nozzle 108 receives a supply of steam through the hose 116 from the steam generator/suction filter 114, and jets out steam (a film-stripping medium) of a predetermined temperature at a predetermined jetting pressure, uniformly along the entire width in the transverse direction of the planographic printing plate 12 from the nozzles which are lined-up linearly.

The film of the portions of the image recording layer of the planographic printing plate 12, which portions have not been exposed and at which portion the film of the image recording layer has not hardened, are steeped in the heat of the steam which is the vapor of the water or the aqueous liquid, and are dissolved by the moisture, and are scraped off by the jetting pressure of the steam. These portions can be washed off even by a small amount of moisture (the film of the unexposed portions can be stripped and dispersed and removed by the steam). As a result, the film of the portions where at least the surface side portion of the image recording layer in the direction of thickness thereof has hardened, remains on the surface of the planographic printing plate 12, whereby an image can be formed.

Note that the conveying portion 104, which corresponds to the portion where the steam jetted from the steam nozzle 108 hits the planographic printing plate 12, is structured by a guide portion which supports, from beneath, the pressure of the steam which is applied to the planographic printing plate 12.

The respective suction nozzles 110, 112 have suction openings which are disposed along the entire width in the transverse direction of the planographic printing plate 12 (the direction orthogonal to the conveying direction of the planographic printing plate 12), and are disposed at positions in vicinities of the both longitudinal direction sides of the steam nozzle 108. Hoses 118, which are pulled out from the steam generator/suction filter 114, are connected to the suction nozzles 110, 112, respectively.

Due to the steam generator/suction filter 114 sucking in air through the hoses 118, the suction nozzles 110, 112 suck in, from the suction openings thereof and together with the surrounding air, the steam which has been used in washing-off the image recording layer of the planographic printing plate 12 and which includes the stripped-off remains of the image recording layer.

The steam generator/suction filter 114 supplies, through the hose 116 and to the steam nozzle 108, steam of a predetermined pressure and a predetermined temperature which the steam generator/suction filter 114 has generated therein. Further, the steam generator/suction filter 114 filters and removes the stripped-off remains of the image recording layer from the drainage which has been sucked from the suction nozzles 110, 112 through the hoses 118, and thereafter, replenishes the remaining liquid component with moisture and carries out reheating of the liquid so as to generate steam of a predetermined pressure and a predetermined temperature therefrom, and supplies the steam to the steam nozzle 108. That is, the drainage of steam can be reused. Note that the steam generator/suction filter 114 may of course be structured such that the moisture which has been sucked in from the suction nozzles 110, 112 is not reused.

As shown in FIG. 1, an air gun 120, which serves as a compressed air blowing means and is structured so as to blow compressed air onto the surface of the planographic printing plate so as to dry and clean the surface, is disposed above the conveying portion 104 and adjacent to the planographic printing plate 12 conveying direction downstream side of the steam developing device.

The air gun 120 is structured by nozzles being lined-up linearly along the entire width of the planographic printing plate 12 in the transverse direction thereof (the direction orthogonal to the conveying direction of the planographic printing plate 12). A hose 124, which is pulled-out from an air generator 122, is connected to the air gun 120.

The air gun 120 jets out, uniformly along the entire transverse direction width of the planographic printing plate 12 and from the nozzles which are lined up linearly, compressed air which is supplied from the air generator 122 through the hose 124. The air gun 120 thereby blows off the moisture remaining on the developed surface of the planographic printing plate 12 (the water drops or the like formed on the planographic printing plate 12 by the vapor cooling), and dries the surface of the planographic printing plate 12, and blows off the stripped-off remains of the image recording layer remaining on the surface of the planographic printing plate 12 so as to clean the surface of the planographic printing plate 12. In this way, at the time of the heating processing in the following post-development heating processing section 102, it is possible to prevent the water soluble material contained in the moisture remaining on the developed surface of the planographic printing plate 12 from being heated and hardening and adhering, and to prevent the stripped-off remains of the image forming layer from being heated and hardening and adhering.

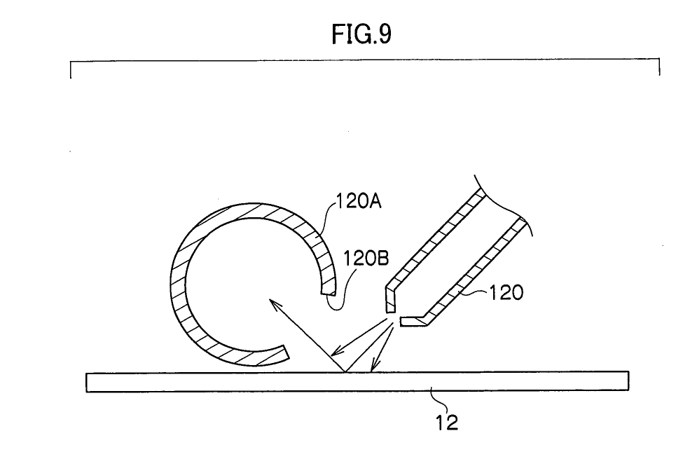

It is preferable to add, to the air gun 120 portion, a scattering preventing means such as that exemplified in FIG. 9 which prevents the stripped-off remains of the image recording layer blown off by the compressed air from scattering. This scattering preventing means is disposed in a vicinity of the air gun 120 and the planographic printing plate 12 at a position where the compressed air jetted from the air gun 120 hits and is reflected by the surface of the planographic printing plate 12.

This scattering preventing means may be structured, for example, such that a cylinder 120A, which has an opening 120B cut-out along the longitudinal direction of the cylinder 120A in correspondence with the entire length of the range of the jetting of the compressed air by the air gun 120, is disposed so as to face the direction in which the compressed air, which hits and is reflected by the surface of the planographic printing plate 12, is blown.

At the scattering preventing means which is structured in this way, when the compressed air is blown toward the surface of the planographic printing plate 12 from the air gun 120, the moisture and the stripped-off remains of the image recording layer enter into the interior of the cylinder 120A from the opening 120B and collect thereat, so as to be prevented from scattering elsewhere.

The cylinder 120A is removably installed at an unillustrated support member, so as to enable the maintenance work of removing the cylinder 120A and washing the cylinder 120A with water at necessary times when the moisture and stripped-off remains of the image recording layer have collected at the interior thereof.

Note that, instead of providing the air gun 120, the moisture on the planographic printing plate 12 can be removed by conveying the planographic printing plate 12 in a state of being tilted at an incline.

As shown in FIG. 1, the post-development heating processing section 102 is disposed at the planographic printing plate 12 conveying direction downstream side of the air gun 120 of the water developing section 100.

The post-development heating processing section 102 thermosets the lower layer side portion (in the direction of thickness) of the image recording layer of planographic printing plate 12 which has been subjected to the water developing processing (i.e., thermosets the portion of the image recording layer at the side thereof fixed to the aluminum support, which portion corresponds to the reverse surface side of the image recording layer).

To this end, a heating means 126, which heats the planographic printing plate 12 conveyed at the conveying portion 104 to a predetermined temperature, is provided at the post-development heating processing section 102. The heating means 126 is structured by a heat roller which heats the planographic printing plate 12 while rolling along and contacting the planographic printing plate 12; a radiation heating means such as a halogen heater, a ceramic heater or the like; a heating fan unit blowing out hot air from nozzles; a heating means carrying out heating by irradiating infrared rays; a heating means carrying out heating by irradiating electromagnetic waves; a heating means carrying out heating by high frequency wave induction; or the like.

At the post-development heating processing section 102, the planographic printing plate 12 which is conveyed in on the conveying portion 104 is heated to a predetermined temperature from the surface thereof by the heating means 126. The lower layer side portion of the image recording layer in the direction of thickness thereof (i.e., the portion at the side fixed to the aluminum support which corresponds to the reverse surface side of the image recording layer) is sufficiently thermoset and fixed to the aluminum support. The post-development heating processing section 102 is structured such that the lower layer side of the image recording layer in the direction of thickness thereof is reliably prevented from being dissolved by the wetting water applied at the printing press and thus the image recording layer is reliably prevented from being stripped off.

Next, the work and operations at the image forming device 10 which is structured as described above will be explained.

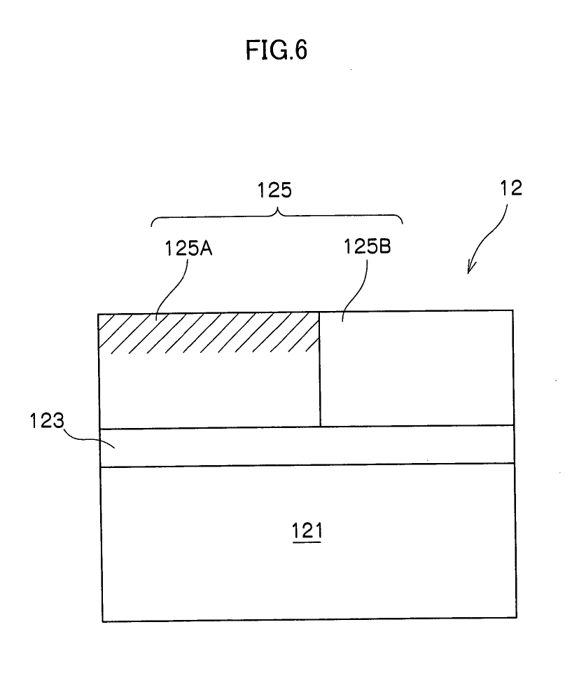

The image forming device 10 utilizes the planographic printing plate 12 in which, as shown in FIG. 6, an anodized covering film 123 as a hydrophilic layer is formed on the surface of an aluminum support 121, and an image recording layer 125 is formed on the top surface of the anodized covering film 123.

At the image forming device 10, when an image is to be formed on the planographic printing plate 12, the undeveloped planographic printing plate 12 is conveyed by the conveying device into the laser recording section 11 at the interior of the image forming device 10, and is held on the outer peripheral surface of the outer drum 20 by the chucking mechanisms such that the preparations for exposure are completed. Thereafter, the laser recording section 11 carries out exposure processing (scanning exposure processing) by scanning, i.e., illuminating the NIR lasers L from the exposure head 26 onto the planographic printing plate 12, so as to form a latent image.

In this exposure processing step, exposure processing is carried out and the latent image is formed by laser light (the NIR lasers L) of a relatively low laser power (e.g., a laser power which is half of or more than half of that of the conventional art) which hardens a portion of the image recording layer 125, which portion is at the surface side of the image recording layer 125 in the direction of thickness thereof (and preferably ⅓ or more of the recording layer at the surface side in the direction of thickness thereof).

In this exposure processing, because the amount of laser power can be reduced, as a result, effects which are similar to improving the sensitivity of the planographic printing plate 12 are achieved.

As shown in FIG. 6, at the planographic printing plate 12 which has been subjected to exposure processing as described above, an exposed image recording layer portion 125A as a portion of the image recording layer 125 is thermoset at the surface side portion thereof. An unexposed image recording layer portion 125B remains as a hydrophilic layer which is not hardened.

The planographic printing plate 12, on which a latent image has been formed as described above, is released from the outer drum 20 by the chucking mechanisms, and is conveyed into the water developing section 100 by the conveying portion 104.

In the water developing section 100, the planographic printing plate 12 which has been conveyed in is subjected to water developing processing at the steam developing device, and is dried and cleaned and finished by the air gun 120.

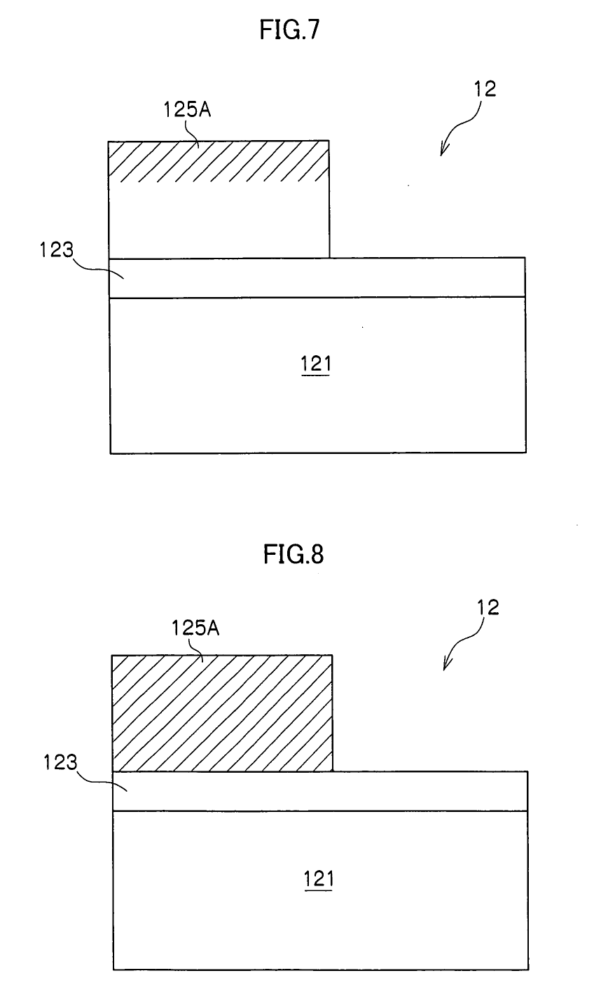

In this water developing processing step, as shown in FIG. 7, the unexposed image recording layer portion 125B of the planographic printing plate 12 is removed. Namely, in this water developing processing step, processing is carried out such that the image recording layer portion 125A of the planographic printing plate 12, which has been exposed and whose surface layer has been hardened, remains, and the unexposed image recording layer portion 125B is squeezed and removed.

The planographic printing plate 12, which has been subjected to water developing processing in the water developing section 100, is conveyed by the conveying portion 104, and is conveyed into the post-development heating processing section 102 and is subjected to heating processing, whereby production of the planographic printing plate 12 on which an image has been formed is completed. The planographic printing plate 12 is conveyed out onto an unillustrated tray or the like of the image forming device 10.

The planographic printing plate 12, on which an image has been formed in this way, is set at an unillustrated printing press and provided for use in printing.

In this heating processing, as shown in FIG. 8, the image recording layer portion 125A, which is the liophilic layer at the planographic printing plate 12 and only the surface layer thereof has been hardened in the state shown in FIG. 7, is heated and hardened all the way to the interface between the image recording layer portion 125A and the anodized covering film 123, so as to be strongly adhered to the surface of the anodized covering film 123. In the heating processing, the image recording layer portion 125A is hardened well so as to have a uniform quality overall.

In a case in which the image recording layer portion 125A is hardened by the laser exposure processing of the planographic printing plate 12 by the conventional method, when the intensity of the illuminated laser light is raised, the surface of the image recording layer portion 125A scatters due to ablation, and moreover, at the portion of the image recording layer portion 125A in the direction of thickness thereof in a vicinity of the anodized covering film 123, the heat escapes toward the aluminum support 121, and therefore, the thermosetting is insufficient, and it is difficult to harden the entire image recording layer portion 125A uniformly. Thus, the capacity of the planographic printing plate 12 to sustain a good printing quality over a large number of printings is about 500 sheets.

In contrast, it was confirmed by actual experimentation that the aforementioned capacity can be drastically improved to about 50,000 sheets with the planographic printing plate 12 at which an image is formed by subjecting the planographic printing plate 12 to exposure processing, and thereafter carrying out water developing processing, and next carrying out post-development heating processing.

Namely, in accordance with the above-described image forming method for planographic printing plates, an excellent ability of the planographic printing plate 12 on which an image has been formed, to sustain a good printing quality over a large number of printings, is realized, and a large number of good prints can be obtained.

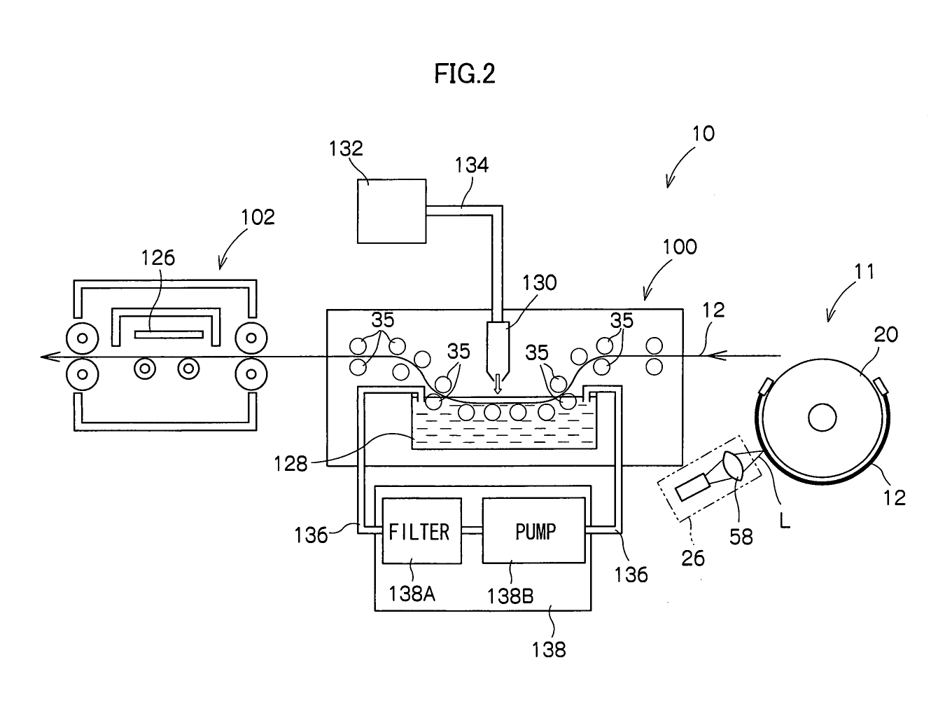

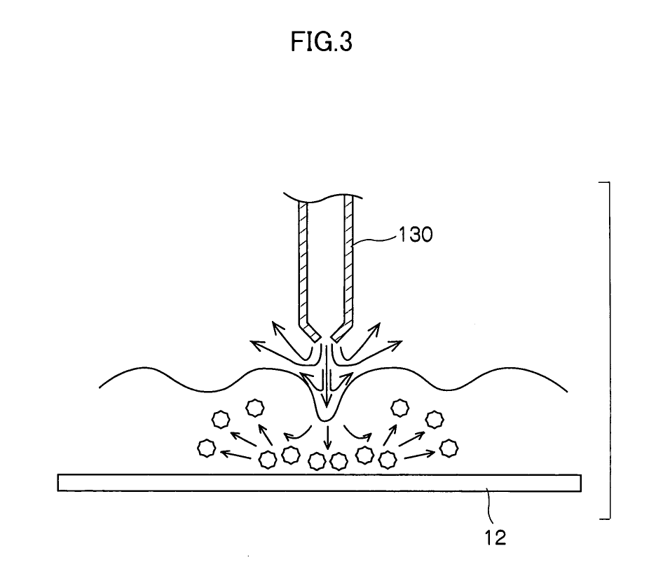

Next, a second embodiment relating to the image forming device for planographic printing plates of the present invention will be described in accordance with FIGS. 2 and 3.

In the present second embodiment, the steam developing device of the image forming device 10 in the above-described first embodiment is replaced by a water developing processing means of another structure.

In the present second embodiment, the water developing section 100 having the structure shown in FIGS. 2 and 3 is provided.

In this water developing section 100, water or an aqueous liquid (water, or an aqueous liquid in which the necessary chemicals are added to water or to an aqueous liquid having the same components as the wetting water used in printing presses) is stored in a water developing tank 128.

In the water developing section 100 shown as an example in FIG. 2, a conveying path, which is a conveying means structured by conveying rollers 35, for the planographic printing plate 12 at a portion of a predetermined range where developing processing is carried out within the water developing tank 128, is set so as to pass along the horizontal direction through a position of a predetermined depth which is near to the liquid surface of the water or the aqueous liquid stored in the water developing tank.

Further, in the water developing section 100, a high-pressure air jetting nozzle 130 is disposed directly above the liquid surface of the water or the aqueous liquid, at a position within the predetermined range where developing processing is carried out at the water developing tank 128 (i.e., in the figure, at the central position of the predetermined range).

The jetting nozzle 130 is structured by nozzles being lined-up linearly along the entire width of the planographic printing plate 12 in the transverse direction thereof (the direction orthogonal to the conveying direction of the planographic printing plate 12). A hose 134, which is pulled-out from an air generator 132, is connected to the jetting nozzle 130.

The jetting nozzle 130 is structured so as to carry out water developing processing by jetting, from the nozzles which are lined up linearly, compressed air (a film-stripping medium), which is supplied from the air generator 132 through the hose 134, uniformly along the entire transverse direction width toward the planographic printing plate 12 directly beneath the liquid surface of the water or the aqueous liquid.

In the water developing processing which uses compressed air jetted out from the jetting nozzle 130, as shown in FIG. 3, the compressed air is jetted out from the jetting nozzle 130 toward the planographic printing plate 12 directly beneath the liquid surface of the water or the aqueous liquid. Thus, the liquid surface of the water or the aqueous liquid which is above the planographic printing plate 12 is pressed locally by the compressed air jetted from the jetting nozzle 130, such that the surrounding water attempts to flow into the sunken portion.

Further, the water or the aqueous liquid, to which pressure has been applied by the compressed air jetted from the jetting nozzle 130, hits the image recording layer of the surface of the planographic printing plate 12, and works to scrape the water soluble material off. The water soluble material which has been scraped off from the surface of the planographic printing plate 12 in this way is dispersed in the water or aqueous liquid.

Namely, in the water developing processing of the image recording layer of the planographic printing plate 12, the film portions of the image recording layer which are unexposed and have not hardened are washed-off by the action of the water or the aqueous liquid to which pressure is applied by the compressed air jetted from the jetting nozzle 130 (i.e., the film of the unexposed portions is stripped and dispersed and removed). Further, the film at the portions of the image recording layer, at which at least the surface side portion in the direction of thickness has hardened, remains on the surface of the planographic printing plate 12. An image is thereby formed.

As shown in FIG. 2, a filtering/circulating device 138, which is for removing the water soluble material dispersed in the water or the aqueous liquid, is connected to the water developing tank 128 via a circulating pipe 136. The filtering/circulating device 138, through the circulating pipe 136, takes out the water or aqueous liquid stored in the water developing tank 128, and filters and removes the remains of the peeled-off film of the image recording layer by a filter 138A, and feeds the water or aqueous liquid by a pump 138B, and returns it into the water developing tank 128.

Further, although not illustrated, a compressed air blowing means, which is structured so as to blow compressed air onto the surface of the planographic printing plate so as to dry and clean the surface, may be provided between the water developing section 100 and the post-development heating processing section 102.

Moreover, although not illustrated, it is possible to use a structure in which developing can be carried out even more stably by warming the water developing tank by a heater or the like so as to set the water developing tank to a predetermined water temperature.

Note that the structures, operations and effects of the present second embodiment other than those described above are similar to those of the first embodiment, and therefore, description thereof will be omitted.

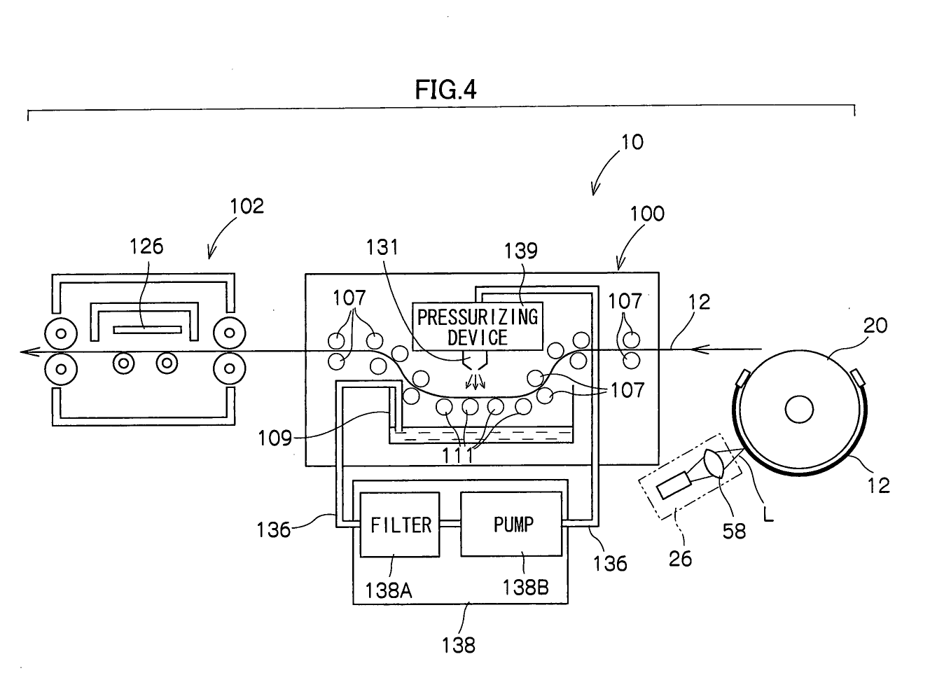

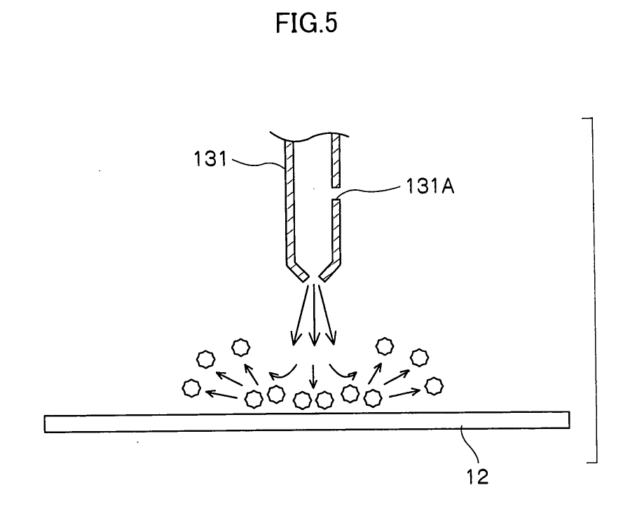

Next, a third embodiment relating to an image forming device for planographic printing plates of the present invention will be described in accordance with FIGS. 4 and 5.

In the present third embodiment, the steam developing device of the image forming device 10 in the above-described first embodiment is replaced by a water developing processing means of another structure.

In the present third embodiment, the water developing section 100 having the structure shown in FIGS. 4 and 5 is provided.

In this water developing section 100, a conveying path, which is the conveying means of the planographic printing plate 12, is structured by lining-up a plurality of conveying rollers 107 at uniform intervals, in order to convey the planographic printing plate 12. A portion of the conveying path is structured so as to, directly above a drain 109 which receives the water or aqueous liquid, curve-in in a U-shape toward the floor of the drain 109.

A jetting nozzle 131 is disposed in the water developing section 100 at a predetermined position above the conveying path which is the conveying means of the planographic printing plate 12 and which is set so as to be convex downward in a U shape toward the interior of the drain 109.

The jetting nozzle 131 is structured by nozzles being lined-up linearly along the entire width in the transverse direction of the planographic printing plate 12 (the direction orthogonal to the conveying direction of the planographic printing plate 12). The jetting nozzle 131 carries out washing-off (stripping and dispersing and removing of the film of the unexposed portions by water or an aqueous liquid) by forcibly jetting out pressurized water or aqueous liquid serving as a film-stripping medium (blowing out the water or aqueous liquid in a jet of a strong stream), onto the surface of the planographic printing plate 12 which is being conveyed on the conveying path which is the conveying means.

Note that supporting/receiving rollers 111, which rotate and contact the planographic printing plate 12 so as to convey the planographic printing plate 12 while supporting the plate surface of the planographic printing plate 12 against the water pressure at the time when the water or aqueous liquid is jetted out onto the planographic printing plate 12, are disposed at positions facing the bottom side of the planographic printing plate 12 at the portion of the conveying path which is the conveying means, which portion corresponds to the position where the pressurized water or aqueous liquid is jetted out from the jetting nozzle 131.

As shown in FIG. 4, at the water developing section 100, there is structured a water or aqueous liquid recirculating fluid circuit which feeds the water or aqueous liquid to the filtering/circulating device 138 through a circulating pipe 136 from the drain 109 which receives and stores the water or aqueous liquid jetted from the jetting nozzle 131, and feeds the water or aqueous liquid through the circulating pipe 136 to a pressurizing device 139, and again jets from the jetting nozzle 131 the water or aqueous liquid which is pressurized by the pressurizing device 139.

Therefore, the circulating pipe 136, whose one end portion is open in a vicinity of the floor portion within the drain 109 which receives and stores the water or aqueous liquid jetted from the jetting nozzle 131, is disposed in the water developing section 100, and is connected to the filtering/circulating device 138.

The filtering/circulating device 138 extracts the water or aqueous liquid stored in the water developing tank 128 through the circulating pipe 136, and by a filter 138A, filters and removes the remains of the peeled-off film of the image recording layer, and thereafter, feeds the filtered water or aqueous liquid by a pump 138 to the pressurizing device 139.

The pressurizing device 139 applies a predetermined high pressure, which is needed for the water developing processing, to the water or aqueous liquid, and uniformly jets out high-pressure jetting water toward the planographic printing plate 12 along the entire transverse direction width thereof from the jetting nozzle 131 at which the nozzles are lined-up linearly, so as carry out the water developing processing.

In the water developing section 100, in order to decrease the amount of water or aqueous liquid which is used in the water developing processing, an air mix-in means may be provided which mixes air into the water or the aqueous liquid which is jetted out from the jetting nozzle 131. As shown in FIG. 5 for example, the air mix-in means may be structured by forming an intake port 131A which is a through hole in a portion of the jetting nozzle 131 so as to mix air into the water or aqueous liquid jetted from the jetting nozzle 131. Or, the air mix-in means may be structured so as to mix air in at the time when the water or aqueous liquid is being pressurized at the pressurizing device 139.

In the water developing processing which is carried out by jetting out high-pressure jetting water from the jetting nozzle 131, as shown in FIG. 5, the high-pressure jetting water jetted from the jetting nozzle 131 hits the image recording layer of the surface of the planographic printing plate 12, and works to scrape off, by the water pressure, the water soluble material which is to be dissolved in the water. The water soluble material which is scraped off from the surface of the planographic printing plate 12 in this way is dispersed in the water or aqueous liquid.

Namely, in the water developing processing of the image recording layer of the planographic printing plate 12, the film portions of the image recording layer which are unexposed and have not hardened are washed-off by the action of the high-pressure jetting water (i.e., the film of the unexposed portions is stripped and dispersed and removed). Further, the film at the portions of the image recording layer, at which at least the surface side portion in the direction of thickness has hardened, remains on the surface of the planographic printing plate 12. An image is thereby formed.

So-called dregs, which are particles of the capsules which once structured the film of the photosensitive layer or are fine fragments of the film of the photosensitive layer, are suspended in the water or aqueous liquid which is used in this washing-off, and flow down into the drain 109.

The water or aqueous liquid is fed from the drain 109 to the filtering/circulating device 138 by the circulating pipe 136, and after the remains of the film of the photosensitive layer have been filtered out at the filter 138A, the water or aqueous liquid is fed by the pump 138 through the circulating pipe 136 to the pressurizing device 139, and high pressure is applied thereto at the pressurizing device 139. Fresh water or aqueous liquid (washing liquid) is always jetted out from the jetting nozzle 131, and good water developing processing can be carried out.

Although not illustrated, an air gun, which is a compressed air blowing means structured so as to jet compressed air onto the surface of the planographic printing plate 12 and dry and clean the surface, may be provided between the water developing section 100 and the post-development heating processing section 102.

Note that the structures, operations and effects of the present third embodiment other than those described above are similar to those of the first and second embodiments, and therefore, description thereof will be omitted.

1. An image forming device for planographic printing plates which, before printing, carries out water developing and heating processing after the water developing, of a planographic printing plate which can be developed by water, the image forming device comprising:
a laser recording section which forms a latent image by laser-exposing an image recording layer portion of the planographic printing plate at a weak laser power of an extent that one-third, at a surface side, of the image recording layer in a direction of thickness thereof can be hardened;
a water developing section which strips film of unexposed portions of the image recording layer by causing a film-stripping medium, which is selected from the group consisting of steam, water, aqueous liquids, and mixtures of a gas and at least one of water and an aqueous liquid, to hit the planographic printing plate on which a latent image has been formed at the image recording layer portion by the laser recording section; and
a post-development heating processing section which heats the planographic printing plate, after the planographic printing plate has been subjected to water developing processing by the water developing section, and hardens the image recording layer portion.

2. The image forming device for planographic printing plates of claim 1, further comprising a filtering/circulating device which recovers the film-stripping medium used in film stripping, removes stripped-off remains of the image recording layer which are contained in the film-stripping medium, adjust the film-stripping medium, and thereafter, feeds the film-stripping medium to the water developing section.

3. The image forming device for planographic printing plates of claim 1, further comprising compressed air blowing means for blowing compressed air onto a surface of the planographic printing plate such that the surface is dried and cleaned, before the planographic printing plate, which has been subjected to the water developing processing, is conveyed to the post-development heating processing section.

4. The image forming device for planographic printing plates of claim 1, wherein the film-stripping medium is steam, and the water developing section is a device which removes the unexposed portions of the image recording layer by blowing, from a steam nozzle, steam of a predetermined temperature and a predetermined jetting pressure, onto the planographic printing plate at which the latent image has been formed by laser exposure on the image recording layer portion.

5. The image forming device for planographic printing plates of claim 4, further comprising a steam generator/suction filter which generates steam of a predetermined temperature and a predetermined pressure, feeds the steam to the steam nozzle for use, then sucks-in and recovers the steam by a suction nozzle, filters out and removes stripped-off remains of the image recording layer, and generates stream by utilizing the remaining liquid.

6. The image forming device for planographic printing plates of claim 1, wherein the film-stripping medium is one of water and an aqueous liquid, and the water developing section includes:
a water developing tank storing the one of the water and the aqueous liquid;
conveying means for conveying the planographic printing plate in the water developing tank such that the image recording layer, on which the latent image has been formed by laser exposure, passes through a position of a predetermined depth below a liquid surface of the water developing tank; and
a jetting nozzle jetting compressed air toward the image recording layer of the planographic printing plate passing through an interior of the water developing tank, and carrying out the water developing processing by making the film-stripping medium at the interior of the water developing tank hit a surface of the planographic printing plate.

7. The image forming device for planographic printing plates of claim 6, further comprising a filtering/circulating device connected to the water developing tank, which filtering/circulating device extracts the one of the water and the aqueous liquid stored in the water developing tank and filters out and removes remains of peeled-off film of the image recording layer, and returns filtered liquid to the interior of the water developing tank.

8. The image forming device for planographic printing plates of claim 1, wherein the film-stripping medium is selected from the group consisting of water, aqueous liquids, and mixtures of a gas and at least one of water and an aqueous liquid; and wherein the water developing section has:
conveying means for conveying the planographic printing plate at which the latent image has been formed by laser exposure on the image recording layer; and
a jetting nozzle for blowing the film-stripping medium, which has been pressurized, toward the image recording layer of the planographic printing plate being conveyed by the conveying means, and stripping and removing the film of the unexposed portions.

9. The image forming device for planographic printing plates of claim 8, further comprising a drain disposed at a lower side of a conveying path, a circulating pipe, a filtering/circulating device, and a pressurizing device, wherein the drain receives therein one of water and aqueous liquid which has been jetted out from the jetting nozzle, and the one of the water and the aqueous liquid is fed from the drain through the circulating pipe to the filtering/circulating device, and stripped-off remains of the image recording layer are filtered out and removed, and the one of the water and the aqueous liquid which remains is fed to the pressurizing device through the circulating pipe, and the one of the water and the aqueous liquid which is pressurized at the pressurizing device is again jetted out from the jetting nozzle.

10. The image forming device for planographic printing plates of claim 8, comprising air mix-in means for mixing air into the one of the water and the aqueous liquid which is jetted out from the jetting nozzle.

11. An image forming device for planographic printing plates which, before printing, carries out water developing and heating processing after the water developing, of a planographic printing plate which can be developed by water, the image forming device comprising:
a water developing section which, by blowing steam of a predetermined temperature and a predetermined jetting pressure from a steam nozzle onto the planographic printing plate at which a latent image has been formed on an image recording layer portion by laser exposure, removes unexposed portions of the image recording layer.

12. The image forming device for planographic printing plates of claim 11, wherein the water developing section includes a steam generator/suction filter which generates steam of a predetermined temperature and a predetermined pressure, feeds the steam to the steam nozzle for use, then sucks-in and recovers the steam by a suction nozzle, filters out and removes stripped-off remains of the image recording layer, and generates stream by utilizing the remaining liquid.

13. The image forming device for planographic printing plates of claim 11, further comprising a post-development heating processing section which heats the planographic printing plate, after the planographic printing plate has been subjected to water developing processing, and hardens the image recording layer portion.

14. The image forming device for planographic printing plates of claim 13, further comprising compressed air blowing means for blowing compressed air onto a surface of the planographic printing plate such that the surface is dried and cleaned, before the planographic printing plate, which has been subjected to the water developing processing, is conveyed to the post-development heating processing section.

15. An image forming device for planographic printing plates, which forms images onto planographic printing plates which can be developed by water, the image forming device comprising:
a water developing tank storing one of water and an aqueous liquid;
conveying means for conveying the planographic printing plate in the water developing tank such that an image recording layer, on which a latent image has been formed by laser exposure, passes through a position of a predetermined depth below a liquid surface of the water developing tank; and
a jetting nozzle jetting compressed air toward the image recording layer of the planographic printing plate passing through an interior of the water developing tank.

16. The image forming device for planographic printing plates of claim 15, further comprising a filtering/circulating device connected to the water developing tank, which filtering/circulating device extracts the one of the water and the aqueous liquid stored in the water developing tank and filters out and removes remains of peeled-off film of the image recording layer, and returns filtered liquid to the interior of the water developing tank.

17. The image forming device for planographic printing plates of claim 15, comprising a post-development heating processing section which heats the planographic printing plate, after the planographic printing plate has been subjected to the water developing processing, and hardens the image recording layer portion.

18. The image forming device for planographic printing plates of claim 17, further comprising compressed air blowing means for blowing compressed air onto a surface of the planographic printing plate such that the surface is dried and cleaned, before the planographic printing plate, which has been subjected to the water developing processing, is conveyed to the post-development heating processing section.

19. An image forming device for planographic printing plates, which forms images onto planographic printing plates which can be developed by water, the image forming device comprising:
conveying means for conveying the planographic printing plate at which a latent image has been formed by laser exposure on an image recording layer; and
a jetting nozzle blowing out one of water and an aqueous liquid, which has been pressurized, toward the image recording layer of the planographic printing plate being conveyed by the conveying means, and stripping and removing film of unexposed portions, and thereby carrying out water developing processing.

20. The image forming device for planographic printing plates of claim 19, further comprising a drain disposed at a lower side of a conveying path, a circulating pipe, a filtering/circulating device, and a pressurizing device, wherein the drain receives therein one of the water and the aqueous liquid which has been jetted out from the jetting nozzle, and the one of the water and the aqueous liquid is fed from the drain through the circulating pipe to the filtering/circulating device, and stripped-off remains of the image recording layer are filtered out and removed, and the one of the water and the aqueous liquid which remains is fed to the pressurizing device through the circulating pipe, and the one of the water and the aqueous liquid which is pressurized at the pressurizing device is again jetted out from the jetting nozzle.

21. The image forming device for planographic printing plates of claim 19, further comprising air mix-in means for mixing air into the one of the water and the aqueous liquid which is jetted out from the jetting nozzle.

22. The image forming device for planographic printing plates of claim 19, further comprising a post-development heating processing section which heats the planographic printing plate, after the planographic printing plate has been subjected to the water developing processing, and hardens the image recording layer portion.

23. The image forming device for planographic printing plates of claim 22, further comprising compressed air blowing means for blowing compressed air onto a surface of the planographic printing plate such that the surface is dried and cleaned, before the planographic printing plate, which has been subjected to the water developing processing, is conveyed to the post-development heating processing section.
